(19) United States
(12) Patent Application Publication
(10) Pub. No.: US 2026/0189664 A1
(43) Pub. Date: Jul. 2, 2026

(54) FIXED RETAIL SCANNERS AND RELATED METHODS FOR DOCUMENT VALIDATION ASSIST IMPROVEMENTS

(71) Applicant: Datalogic IP Tech S.R.L., Calderara Di Reno (IT)

(72) Inventor: Michael Ahten, Eugene, OR (US)

(73) Assignee: Datalogic IP Tech S.R.L., Calderara Di Reno (IT)

(21) Appl. No.: 19/007,374

(22) Filed: Dec. 31, 2024

(51) Int. Cl. H04N 1/028; G06T 7/00; G06V 10/141; G06V 10/143; G06V 30/42; G07D 7/004; G07D 7/12; H04N 1/00

(52) U.S. Cl. CPC H04N 1/02815; G06T 7/0002; G06V 10/141; G06V 10/143; G06V 30/42; G07D 7/004; G07D 7/12; H04N 1/00405; G06T 2207/30176; G07D 2207/00

(57) ABSTRACT

The disclosure includes a scanning system and related method for operating a document validation assist mode, such as for detecting counterfeit currency or other documents using a data reader such as a barcode reader. The data reader includes a camera, a visible illumination source, a non-visible illumination source, and a camera configured to capture a first image under a first illumination condition using the at least one visible light source, a second image under a second illumination condition using the at least one non-visible light source during a document validation assist mode. The electronic display is operably coupled to the data reader to receive the images from the data reader during the document validation assist mode. The electronic display is configured to display the first and second images in an alternating fashion at a frequency slower than a minimum flicker fusion frequency for human vision.

### TECHNICAL FIELD

The present disclosure relates generally to scanners or code readers, and more particularly, to fixed retail scanners having security validation processes for assisting in the recognition of valid documents, such as currency notes.

### BACKGROUND

Data reading devices are used to read optical codes, acquire data, and capture a variety of images. Optical codes typically comprise a pattern of dark elements and light spaces. There are various types of optical codes, including one-dimensional codes, such as a Universal Product Code (“UPC”) and EAN/JAN codes, and stacked and two-dimensional codes, such as PDF417 and Maxicode codes. Data reading devices are well known for reading UPC and other types of optical codes on packages, particularly in retail stores. One common data reader in such systems is an imaging reader that employs an imaging device or sensor array, such as a CCD (charge coupled device) or CMOS (complementary metal oxide semiconductor) device. Imaging readers can be configured to read both 1-D and 2-D optical codes, as well as other types of optical codes or symbols and images of other items.

Data readers have provided some assistance for a cashier to identify certain security features in currency notes or other documents. Some conventional methods for detection of counterfeit articles have relied on displaying an image of the article on an electronic display screen for the cashier or other person to attempt to make an accurate detection by visual inspection. The image capture may have been under different lighting conditions (e.g., IR illumination, UV illumination) to be displayed. In some conventional applications, the captured image is displayed to appear as a stand-alone image by itself for the inspector to look for security features. In some other conventional approaches, the captured image is concurrently displayed side-by-side a reference image for the inspector to look for security features.

When checking the image of the currency note, the person checking the currency may not know what to look for and the IR or UV features on the note may not be obvious. When looking at a static image, it may be difficult to see the IR or UV features, because there may not be a lot of contrast between the IR or UV features and other parts of the note. As a result, the inventor has appreciated a need for an improved device, method, and system for counterfeit article detection.

### BRIEF SUMMARY

A scanning system includes a data reader and an electronic display. The data reader comprises at least one camera configured to capture images of an item, at least one visible illumination source, at least one non-visible illumination source, and at least one processor configured to: control the exposure of the at least one camera and activate the at least one visible illumination source and the non-visible illumination source; decode optical symbols on the item from images captured during a decoding operational mode; and capture a first image under a first illumination condition using the at least one visible light source, a second image under a second illumination condition using the at least one non-visible light source during a document validation assist mode. The electronic display is operably coupled to the data reader to receive the images from the data reader during the document validation assist mode. The electronic display is configured to display the first and second images in an alternating fashion at a frequency slower than a minimum flicker fusion frequency for human vision.

A method of operating a scanning system to perform a document validation assist mode is disclosed. The method comprises capturing a first image under a first illumination condition of non-visible light, capturing a second image under a second illumination condition of visible light, transmitting the first image and the second image from a data reader to a connected electronic display, and alternatingly displaying the first and second images on the connected electronic display at a rate less than a minimum flicker fusion frequency for human vision.

A method of operating a scanning system to perform a document validation assist mode is disclosed. The method comprises capturing a first image under a first illumination condition that shows at least one security feature present on the document, capturing a second image under a second illumination condition that does not show the at least one security feature present on the document, transmitting the first image and the second image from a data reader to a connected electronic display, and alternatingly displaying the first and second images on the connected electronic display at a rate less than a minimum flicker fusion frequency for human vision to allow a user to distinguish between the images and identify the at least one security feature.

### BRIEF DESCRIPTION OF THE DRAWINGS

FIG. 1 is a perspective view of a data reader according to an embodiment of the disclosure.

FIG. 2 is a perspective view of a data reader according to an embodiment of the disclosure.

FIG. 3 is a simplified block diagram of an illustrative data reading system according to an embodiment of the disclosure.

FIG. 4 is a simplified block diagram of certain components mounted on the main board according to an embodiment of the disclosure.

FIGS. 5-7 are different simplified block diagrams of the various imager modules according to an embodiment of the disclosure.

FIG. 8 is a simplified block diagram of a data reading system including a data reader and a display according to an embodiment of the disclosure.

FIG. 9 is a flowchart illustrating a method of operating a data reader system to perform a document validation assist mode according to embodiments of the disclosure.

FIGS. 10A-10B show a simplified diagram of the electronic display of FIG. 8 at different instances in time during the document validation assist operation according to embodiments of the disclosure.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operably connected with each other, such as connected through a direct connection or through an indirect connection (e.g., via another structure or component).

“Image data” as used herein includes both individual frames as well as multiple frames (e.g., streaming video). Image data may be captured by one or more imagers positioned at various within the housing of the fixed retail scanner, such as in a horizontal base unit or a vertical bonnet of a bi-optic scanner having imagers positioned in two different planes. Single plane scanners (e.g., horizontal or vertical only housings) are also contemplated and within the scope of the disclosure. Image data may also be captured by one or more imagers positioned external to the primary scanning unit, such as peripheral devices (e.g., top-down reader imagers, security imagers, bottom of basket readers, etc.) that may also provide image data to the fixed retail scanner and/or remote systems.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

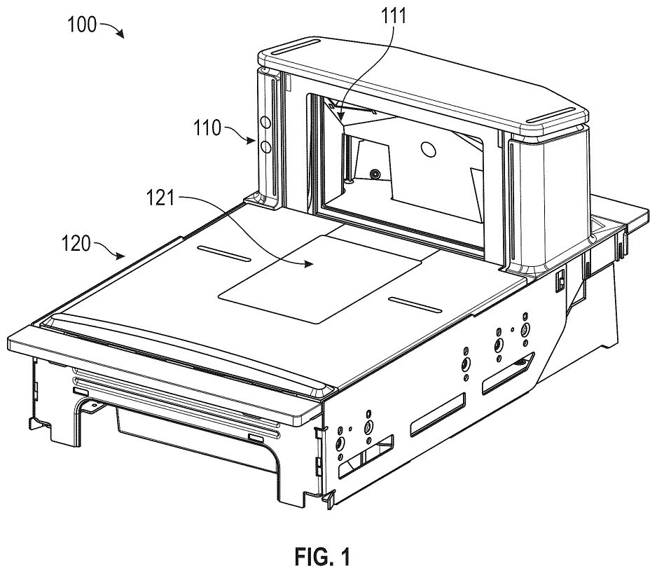

FIG. 1 is a perspective view of a data reader 100 according to an embodiment of the disclosure. The data reader 100 may be a bi-optic fixed retail scanner having a vertical housing 110 and a horizontal housing 120. The vertical housing 110 may include a structure that provides for one or more camera fields-of-view (through a vertical window 111) within a generally vertical plane across the read zone of the data reader 100. The vertical structure provides an enclosure for one or more cameras and other optical elements (e.g., lenses, mirrors, etc.) and electrical elements (e.g., cables, circuit boards, etc.) therein. The horizontal housing 120 may include a structure that provides for one or more camera fields-of-view (through a horizontal window 121) within a generally vertical plane across the read zone of the data reader 100. The horizontal structure provides an enclosure for one or more cameras and other optical elements (e.g., lenses, mirrors, etc.) and electrical elements (e.g., cables, circuit boards, etc.) therein. Thus, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field-of-view may be physically located within the vertical structure and vice versa.

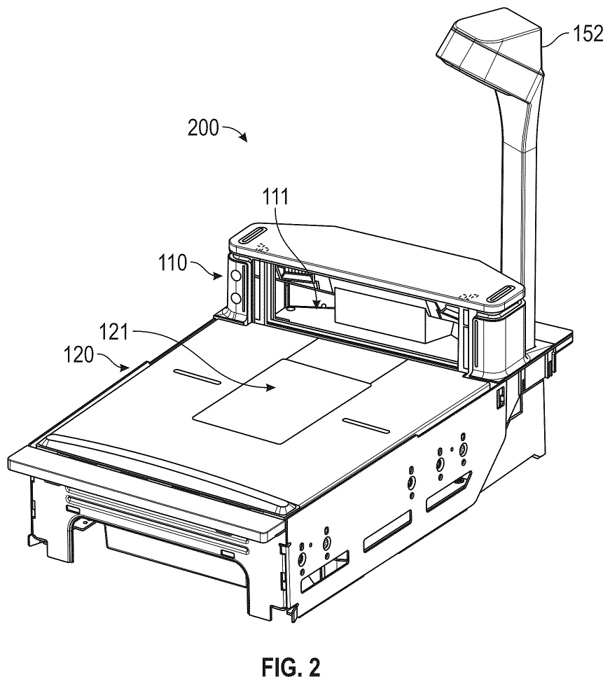

FIG. 2 is a perspective view of an illustrative data reader 200 according to an embodiment of the disclosure. As with the data reader of FIG. 1, the data reader of FIG. 2 may also be a bi-optic fixed retail scanner having a vertical housing 110 and a horizontal housing 120. The data reader 200 may also include a top-down reader (TDR) 152 that includes a stand connected to the data reader 100 with a head that includes one or more imagers therein. Such imager(s) typically provide a generally close overhead (angled) view of the read zone to provide a top view of a product whereas internal cameras may be better suited for capturing images of the bottom and/or sides of the object within the read zone.

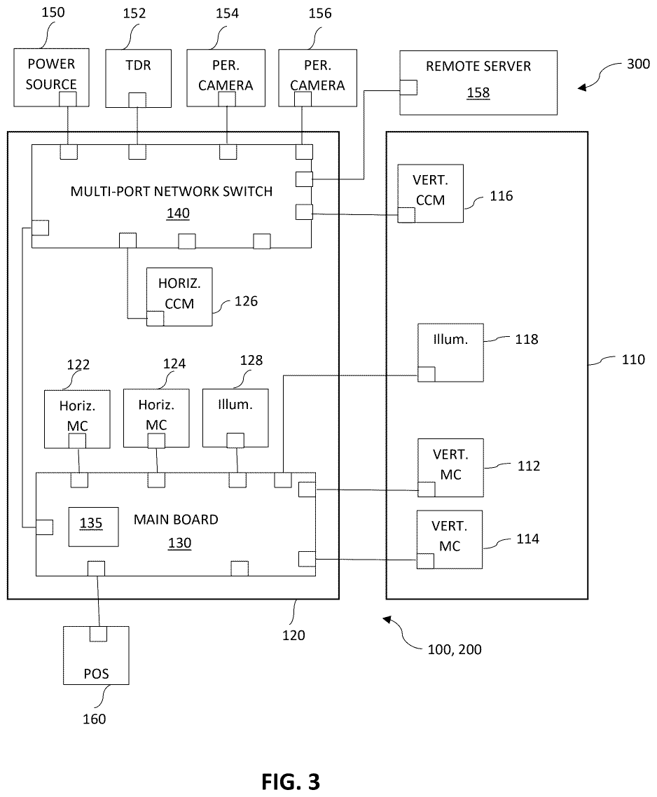

The vertical housing 110 of FIG. 2 may have a lower profile bonnet compared to that of FIG. 1, which may result in internal cameras having a lower incidence angle. Thus, such a form factor may be particularly well suited to include the TDR 152 (FIG. 3) as an optional add-on to the data reader 200. However, a TDR 152 may also be coupled to the data reader 100 of FIG. 1 having the taller bonnet. Such a TDR may need to be taller to accommodate the taller bonnet. In addition, some embodiments may include additional TDRs, such as on the other side of the bonnet, to provide another top view of the read zone. Thus, some embodiments may include one or more TDRs for data readers having different sized bonnets. It is also recognized that some embodiments may include single plane data readers such that certain features described herein are wholly located within a single plane housing (e.g., horizontal), which may further be coupled to other external devices or peripherals.

Different configurations and details regarding the construction and components of a fixed retail scanner are contemplated. For example, additional features and configurations of devices are described in the following patents and patent applications: U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READE,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Patent Application Publication No. 2020/0125812, filed Dec. 2, 2019, and entitled “DATA COLLECTION SYSTEMS AND METHODS TO CAPTURE IMAGERS OF AND DECODE INFORMATION FROM MACHINE-READABLE SYMBOLS,” the disclosure of each of which is incorporated by reference in their entirety. Such fixed retail scanners may be incorporated within assisted checkout stations having a clerk assisting a customer, while some embodiments include self-checkout stations in which the customer is the primary operator of the device. Such components and features may be employed in combination with those described herein.

FIG. 3 is a simplified block diagram of an illustrative data reading system 300 according to an embodiment of the disclosure. The data reading system 300 may include a data reader 100, 200 that may be operably coupled with one or more of a power source 150, the top-down reader (TDR) 152, peripheral cameras 154, 156, a remote service 158, or a point-of-sale (POS) system 160.

The data reader 100, 200 may be a bi-optic fixed retail scanner having a vertical housing 110 and a horizontal housing 120. The data reader 100, 200 may be installed in a retail environment (e.g., grocery store), which typically is disposed within a counter or other support structure of an assisted checkout lane or a self-checkout lane. The vertical housing 110 may include a structure that provides for one or more camera fields-of-view (through a vertical window) within a generally vertical plane across the read zone of the data reader 100, 200. The vertical structure provides an enclosure for one or more cameras 112, 114, 116, active illumination assemblies 118 (e.g., LED assemblies), and other optical elements (e.g., lenses, mirrors, etc.) and electrical elements (e.g., cables, circuit boards, etc.) therein. The horizontal housing 120 may include a structure that provides for one or more camera fields-of-view (through a horizontal window) within a generally vertical plane across the read zone of the data reader 100, 200. The horizontal structure provides an enclosure for one or more cameras 122, 124, 126, active illumination elements 128 (e.g., LED assemblies), and other optical elements (e.g., lenses, mirrors, etc.) and electrical elements (e.g., cables, circuit boards, etc.) therein. Thus, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field-of-view may be physically located within the vertical structure and vice versa.

The data reader 100, 200 may include one or more different types of imagers, such as monochrome imagers and/or color imagers. For example, vertical monochrome cameras 112, 114 may be configured to capture monochrome images through the vertical window of the data reader 100, 200. Likewise, horizontal monochrome cameras 122, 124 may be configured to capture monochrome images through the horizontal window of the data reader 100, 200. Vertical color camera module (CCM) 116 may be configured to capture color images through the vertical window of the data reader 100, 200. Likewise, horizontal color camera module (CCM) 126 may be configured to capture color images through the horizontal window of the data reader 100, 200. Monochrome images may be analyzed (e.g., by a decoder) to decode one or more indicia (e.g., 1D barcodes, 2D barcodes, optical character recognition, digital watermarks, etc.). Color images may be analyzed (e.g., by an image processor) to perform analysis on the images where color information may be particularly useful in performing certain functions, such as produce recognition, item recognition or verification, and/or security analysis. Such analysis may be performed by local and/or remote processors that may contain an artificial intelligence (AI) engine or otherwise configured to perform other machine learning techniques.

The data reader may further include a main board 130 and a multi-port network switch 140. As shown herein, the main board 130 and the multi-port network switch 140 may be physically housed within the horizontal housing 120. Bi-optic readers tend to have larger horizontal housings in order to provide support for the device within a cavity in a counter, which also provides space for a scale (not shown) used to weigh produce or other items sold by weight or otherwise perform weighing of items when placed on the horizontal surface (often called a “weigh platter”). It is contemplated that some embodiments may include the main board 130 and/or the multi-port network switch 140 to be physically located within the vertical housing 110. In such an embodiment where one of the multi-port network switch 140 or the main board 130 is physically located within the vertical housing 110 and the other is physically located within the horizontal housing 120, the two boards may be generally oriented orthogonal to each other similar to the orientation of the windows or other angled arrangements (e.g., slightly angled orientations such as being in the range of ±10° from orthogonal). The ports may be at least somewhat aligned in the orthogonal direction or other arrangement to accommodate easy connection of network cables therebetween.

The main board 130 may be operably coupled with the vertical monochrome imagers 112, 114 and the horizontal monochrome imagers 122, 124. These connections may be via a communication interface (e.g., a MIPI interface). The main board 130 may have decoding software embedded therein such that one or more on-board processors 135 may receive monochrome images to perform decoding on the optical indicia and provide the decoding result to a point-of-sale (POS) system 160 operably coupled thereto to complete a transaction. The one or more on-board processors 135 may also be configured to provide control (e.g., coordination or synchronization) of the various components of the system including camera exposure and timing of active illumination assemblies 118, 128 of the system. Although a single block is shown representing one or more on-board processors 135, it is contemplated that some embodiments may include multiple processing components (e.g., microprocessors, microcontrollers, FPGAs, etc.) configured to perform different tasks, alone or in combination, including object detection, system control, barcode decoding, optical character recognition, artificial intelligence, machine learning analysis, or other similar processing techniques for analyzing the images for product identification or verification or other desired events.

The multi-port network switch 140 may be operably coupled to vertical CCM 116 and horizontal CCM 126 located within the data reader 100, 200. The multi-port network switch 140 may also be operably coupled with main board 130 located within the data reader 100, 200. Multi-port network switch 140 may also be operably coupled to the power source 150 as well as peripheral devices, such as the TDR 152, peripheral cameras 154, 156, and/or the remote server 158. The number, and types of peripheral devices, may depend on a desired application within a retail environment. The TDR 152 may be configured as a stand connected to the data reader 100, 200 that typically provides a generally close overhead (angled) view of the read zone to provide a top view of a product whereas internal cameras 112, 114, 116, 122, 124, 126 may be better suited for capturing images of the bottom and/or sides of the object within the read zone. Peripheral cameras 154, 156 may be located remotely from the data reader 100, 200, such as being mounted on a ceiling or wall of the retail environment to provide additional views of the read zone or checkout area. Such views may be useful for security analysis of the checkout area, such as product verification, object flow, human movements, etc. Such analysis may be performed by a remote service or other local devices (e.g., located on or otherwise coupled to the main board 130 or multi-port network switch 140). Other peripheral devices may be located near the data reader 100, 200, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS 160 may be coupled directly to the main board 130. Such a connection may be via communication interfaces, such as USB, RS-232, or other such interfaces. In some embodiments, the POS 160 may be coupled directly to the multi-port network switch 140 if so enabled (e.g., as an Ethernet connected device).

The multi-port network switch 140 may be implemented on a separate board from the main board 130. In some embodiments, the multi-port network switch 140 may be implemented on the main board 130 that also supports the one or more processors 135 also described herein. The multi-port network switch may include multiple ports to provide advanced network connectivity (e.g., Ethernet) between internal devices (e.g., CCMs 116, 126) within the data reader 100, 200 and external devices (e.g., TDR 152, peripheral camera(s) 154, 156, remote server 158, etc.) from the data reader 100, 200. Thus, the multi-port network switch 140 may provide an Ethernet backbone for the elements within the data reader 100, 200 as well as for external devices coupled to the data reader 100, 200 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products and/or devices configured to provide network synchronization and communication with multiple network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reader 100, 200.

Although FIG. 3 shows one block for active illumination assemblies 118, 128 in each of the vertical and horizontal housings 110, 120, some embodiments may include multiple such assemblies in each of the horizontal and vertical housings 110, 120 (as will be described further below) in order to provide for different lighting options at different angles across the read zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130, such as a control panel or other such device (e.g., within the vertical section). In yet other embodiments, the illumination assemblies 118, 128 may be coupled to the multi-port network switch 140 which may route triggering controls from the main board 130. TDR 152 and one or more of the peripheral cameras 154, 156 may also include associated illumination assemblies. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by the cameras 112, 114, 116, 122, 124, 126. Monochrome images may be captured by monochrome cameras 112, 114, 122, 124 and color images may be captured by color cameras 116, 126. The multi-port network switch 140 may be configured to coordinate (e.g., synchronize) timing of camera exposure and active illumination (e.g., white illumination) with the color cameras 116, 126 (as controlled by the controller on the main board 130) to occur in an offset manner with the timing of the camera exposure and active illumination (e.g., red illumination) with the monochrome cameras 112, 114, 122, 124.

Image data (e.g., streaming video, image frames, etc.) from the color cameras 116, 126 may be routed through the multi-port network switch 140 to the processing/analysis modules located internal to the data reader 100, 200, such as the one or more processors 135 supported by the main board 130. As such, image analysis (e.g., AI, machine learning, OCR, object recognition, item validation, produce recognition, analytics, etc.) may be performed on the color images internally within the data reader 100, 200 by the one or more processors 135 supported by the main board 130. In some embodiments, barcode decoding may also be performed on the color images internally within the data reader 100, 200 by the one or more processors 135 supported by the main board 130. Image data from the color cameras 116, 126 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the color images externally to the data reader 100, 200 by external devices coupled through the multi-port network switch 140. Such color images or other data stream may be routed directly to the network connected external devices through the multi-port network switch 140 without first being received by the main board 130 (if at all). In other words, image data may be passed from at least one imager internal to the data reader through the at least one multi-port network device 140 and on to at least one external device bypassing the main board 130. Having a connection to both the main board 130 as well as to external devices via the multi-port network switch enables image data to be provided to internal as well as external processing resources.

Image data from the monochrome cameras 112, 114, 122, 124 may be provided to the main board 130 to the processing/analysis modules located internal to the data reader 100, 200 such as the one or more processors 135 supported by the main board 130. As such, barcode decoding may also be performed on the color images internally within the data reader 100, 200 by the one or more processors 135 supported by the main board 130. In some embodiments, image analysis (e.g., AI, machine learning, OCR, object recognition, item validation, produce recognition, analytics, etc.) may be performed on the monochrome images internally within the data reader 100, 200 by the one or more processors 135 supported by the main board 130. Image data from the monochrome cameras 112, 114, 122, 124 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the monochrome images externally to the data reader 100, 200 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may be routed through the multi-port network switch 140 to the processing/analysis modules located internal to the data reader 100, 200, such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reader 100, 200 by the one or more processors 135 supported by the main board 130. In some embodiments, barcode decoding may also be performed on such images internally within the data reader 100, 200 by the one or more processors 135 supported by the main board 130. Image data from the TDR 152 or other external peripheral cameras 154, 156 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on these images externally to the data reader 100, 200 by external devices coupled through the multi-port network switch 140. Such images or other data stream may be routed directly to the network connected external devices through the multi-port network switch 140 without first being received by the main board 130 (if at all).

The multi-port network switch 140 may be coupled to the main board 130 via a single cable configured to provide power and communication to the main board 130. Power may be provided to the system via power source 150 via the multi-port network switch 140, which in turn provides power (e.g., power over Ethernet (PoE)) to the main board 130 and the color cameras 116, 126. Monochrome cameras 112, 114, 122, 124 and illumination assemblies 118, 128 may be powered via the main board 130.

Features of employing the multi-port network switch 140 as a primary backbone for communication and power to interface between both internal and external components of the system include enabling power, communications, and camera/illumination synchronization to occur over a single cable between such connected components. In addition, precision time protocol (PTP), generic precision time protocol (GPTP), time sensitive networking (TSN) may provide an improved synchronization (e.g., within 1 microsecond error) for an open standard, widely supported, single cable solution. In addition, scanner maintenance tools may be simplified via improved network connectivity.

In some embodiments, the multi-port network switch 140 may be disposed within an external module having its own housing separate from the data reader 100. The multi-port network switch 140 may, thus, be located outside of the bioptic housing of the data reader 100 but may operably couple to the main board 130 and internal devices (e.g., vertical CCM 116, horizontal CCM 126) as well other external devices (e.g., TDR 152, cameras 154, 156, server 158, etc.) for providing the network backbone for communication and/or power as described above.

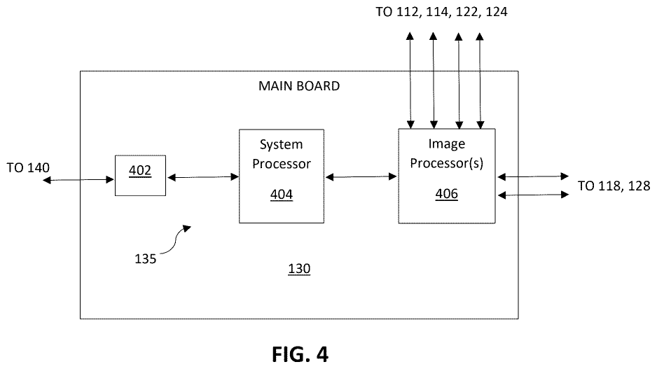

FIG. 4 is a simplified block diagram of certain components mounted on the main board 130 according to an embodiment of the disclosure. In particular, further details are provided regarding the one or more processors 135 that may include an Ethernet physical layer 402, a system processor 404, and an image processor 406. Additional processing elements are also contemplated among the one or more processors 135, such as, for example, an artificial intelligence (AI) accelerator disposed on the main board 130 and coupled to the system processor 404 (e.g., via insertion into a PCIe slot on the main board 130).

The system processor 404 may be coupled to each of the Ethernet physical layer 402 and the image processor 406. The Ethernet physical layer 402 may be coupled with the multi-port network switch 140 to provide an interface between the main board 130 and the multi-port network switch 140. The image processor 406 may be coupled to the monochrome imagers 112, 114, 122, 124 to provide control (e.g., sync signal) and to receive monochrome images therefrom. The image processor 406 may be configured to receive and format image data from the cameras 112, 114, 122, 124 before being received by the system processor 404. In some embodiments, multiple image processors may be present such that each camera 112, 114, 122, 124 may have its own image processor associated therewith. In some embodiments, cameras may share an image processor for transmission to the system processor 404. For example, a single image processor (e.g., FPGA) may be configured to combine (e.g., concatenate) the image data from each of the monochrome cameras 112, 114, 122, 124 for the system processor to receive multiple views at a single point in time through one input. An example of such a process is described in U.S. Patent Publication No. 2022/0207969, filed Dec. 31, 2020, and entitled “FIXED RETAIL SCANNER WITH ANNOTATED VIDEO AND RELATED METHODS,” the disclosure of which is incorporated by reference in its entirety. Image processor 406 may also be coupled to the illumination assemblies 118, 128 to provide control thereto (e.g., sync signal). In some embodiments, the sync signal may be generated by one of the Ethernet physical layer 402 or the system processor 404, and which may be based on a system clock signal.

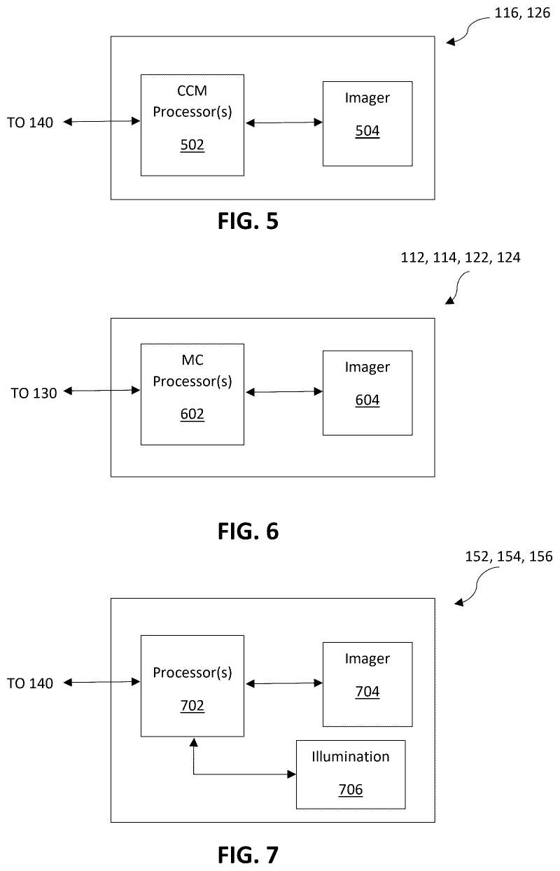

FIGS. 5-7 are different simplified block diagrams of the various imager modules according to an embodiment of the disclosure. For example, FIG. 5 may refer to one of the color camera modules 116, 126, FIG. 6 may refer to one of the monochrome camera (MC) modules 112, 114, 122, 124, and FIG. 7 may refer to one of the TDR 152 or peripheral cameras 154, 156 as examples.

Referring to FIG. 5, the color camera module (CCM) 116, 126 may include a CCM processor 502 that couples to a color imager 504 and to the multi-port network switch 140. The CCM processor 502 may include one or more processors that perform different functions, such as control, formatting, and/or certain analysis functionality, etc. Active illumination for the color camera module 116, 126 may occur off-board via separate illumination assemblies 118, 128. In some embodiments, separate on-board processors may not be present for one or more of the CCM modules 116, 126 such that the control for such may be directly from the main board (e.g., system processor 404) and/or via the multi-port network switch 140 rather than with its own CCM processor 502.

Referring to FIG. 6, the monochrome camera module 112, 114, 122, 124 may include a MC processor 602 that couples to a monochrome imager 504 and to the main board 130 directly. However, it is also contemplated that the monochrome imagers 504 may be connected to the multi-port network switch 140. The MC processor 602 may include one or more processors that perform different functions, such as control, formatting, and/or certain analysis functionality, etc. Active illumination for the MC camera module 112, 114, 122, 124 may occur off-board via separate illumination assemblies 118, 128. In some embodiments, separate on-board processors may not be present for one or more of the MC camera modules 112, 114, 122, 124 such that the control for such may be directly from the main board (e.g., system processor 404 and/or image processor 406) rather than its own MC processor 602.

Referring to FIG. 7, the TDR 152 or other peripheral cameras 154, 156 may include a processor 702 that couples to an imager 704 (e.g., color and/or monochrome depending on application) and to the multi-port network switch 140. The processor 702 may include one or more processors that perform different functions, such as control, formatting, and/or certain analysis functionality, etc. In some embodiments, certain camera modules (e.g., TDR 152 or other peripheral cameras 154, 156) may have their own active illumination assembly 706 associated therewith that may different than the illumination assemblies 118, 128 within the bi-optic housing. The illumination assembly 706 may be located on-board as shown or may be provided at a separate location that may still be within the camera module housing. In some embodiments, separate on-board processors may not be present for the TDR 152 such that the control for such may be directly from the main board (e.g., system processor 404) and/or via multi-port network switch 140 rather than with its own TDR processor 702.

Synchronization of at least some of the active illumination source (e.g., assemblies 118 128, 706, etc.) with each other and with the exposures of the corresponding camera modules (e.g., modules 112, 114, 122, 124, 116, 126, 152, 154, 156, etc.) may be based on time stamps corresponding to packets being generated and received over the network (e.g., IEEE 1588 Precision Time Protocol) when generating and transmitting the sync signal to each device. Each device may determine the elapsed time between packet generation and reception based on the time stamps in order to synchronize with each other and adjust the illumination/exposure scheme designated for each device.

As an example, each device (e.g., system processor 404, horizontal CCM 126, vertical CCM 116, TDR 152, and other peripheral cameras) connected to the multi-port network switch 140 may generate a sync signal (e.g., 1 PPS sync signal) that align with each other based on a common time base. Within each device, one or more separate counters may control the generation of trigger signals for the imager and illumination control signals for the active illumination. The counter(s) may cycle through a sequence of imager triggers and illumination control signals (that may be spaced a predetermined time to account for actual activation times). These internal counters may be overlayed with the internally managed sync signal such that the sync event marks the beginning of the counter time period. Within each device, the respective internal counter may be used to define when the actual trigger signals for imagers and/or illuminations are to be activated relative to the start of the counter (and the 1 PPS sync signal). As an example, the sync signal may initiate the internal counters within a respective device and/or adjust the count values loaded into the counters in order to synchronize across the system. A frame counter may have a duration that defines how often the frame sequence occurs for the cameras controlled by the respective device. An illumination counter may have a duration that defines how often the illumination sequence occurs for different illumination groups controlled by the respective device. In some embodiments, the illumination counter is loaded with half the frame period. As a result, the illumination may be activated at a higher rate than the imagers which may reduce flicker perceived by the user. The actual trigger/activation signal for the camera or imager may be at a predefined time within the duration of the respective counter. If a different illumination scheme is desired, the system processor may load different trigger values and/or count values to the respective registers throughout the different devices. Each counter may expire (e.g., decrement or increment) and reload (e.g., when it reaches zero or some other value) based on its own frequency (e.g., 1 MHz) that may be different than the sync signal.

As sync signals are adjusted depending on packet time stamps during regular communication over the network (e.g., IEEE 1588), the sync signals generated on each device may separately be adjusted to the common time base, which in turn causes the overlayed counters on each device to align as the overlayed counters are dependent on the 1 PPS sync signal. Because each device maintains its own 1 PPS sync signal and internal counter that is overlayed thereto, synchronization may be maintained without needing to send separate synchronization signals to each other, but rather adjusted based on network communications. Thus, for every network sync signal, these counters may operate through the different stages with the adjusted network sync signal operating to periodically realign the internal counters of each device. Although the sync signal is sometimes referred herein to as 1 pulse per second (PPS), other frequencies for generation of this synchronization clock are also contemplated, which could result in more frequent or less frequent synchronization of the system time base as desired.

Additional details regarding examples of various arrangements and methods of operation (e.g., synchronization, control, etc.) are described in U.S. Pat. No. 12,045,686, issued July 23, 2024, and entitled “FIXED RETAIL SCANNER WITH MULTI-PORT NETWORK SWITCH AND RELATED METHODS,” the disclosure of which is incorporated by reference herein in its entirety. Additional details regarding examples of various arrangements of illumination sources and related operational modes are described in U.S. Pat. No. 11,843,744, issued Dec. 12, 2023, and entitled “IMAGE-READING DEVICE HAVING CONFIGURABLE MULTI-MODE ILLUMINATION SEQUENCES AND MONOCHROME COLOR IMAGE CAPTURE SEQUENCES AND RELATED METHODS,” and U.S. Patent Publication No. 2023/0206015, filed Nov. 29, 2022, and entitled “FIXED RETAIL SCANNERS WITH ILLUMINATION ASSEMBLIES HAVING DIFFERENT SUB-GROUPS OF LEDS AND RELATED METHODS,” the disclosures of each of which is incorporated by reference herein in their entirety. At least some of such LEDs described in these references may emit visible and/or non-visible (e.g., infrared, UV) according to embodiments of the disclosure.

Many types of documents, such as currency, have security features that are only visible under infrared (IR) or ultraviolet (UV) illumination. In some embodiments, the data reading system may be configured to provide assistance to a user for document validation (e.g., currency notes, passports, documents with watermarks, etc.) via image capture of the document under different lighting conditions and displaying the images on a display (e.g., video monitor) in an alternating manner in a way that makes certain markings easier to discern by the user. For example, in one embodiment, the different images may be displayed at a frequency that is slower than a flicker fusion frequency of human vision. In most cases, the average rate at which humans stop seeing flicker is about 60 Hz, thus, in this industry most data readers have illumination pulse rates of 50 Hz to 60 Hz for capturing images. An example of such data readers is described in U.S. Pat. No. 7,234,641, issued Jun. 26, 2007, and entitled “ILLUMINATION PULSING METHOD FOR A DATA READER,” the disclosure of which is incorporated by reference herein in its entirety.

When viewing the image of documents, such as a currency note, under IR illumination to check its validity, the cashier may not know what to look for or may not readily notice the IR features. For example, when looking at a static image or a steady state set of images, it may be difficult to see the IR features, because there may not be a lot of contrast between the IR features and other parts of the currency note. However, human brains tend to discern differences between images and are very good at noticing flicker, when part of an image changes from light to dark. By switching between IR and visible illumination at a slow frequency, the IR features on the currency note may become more noticeable.

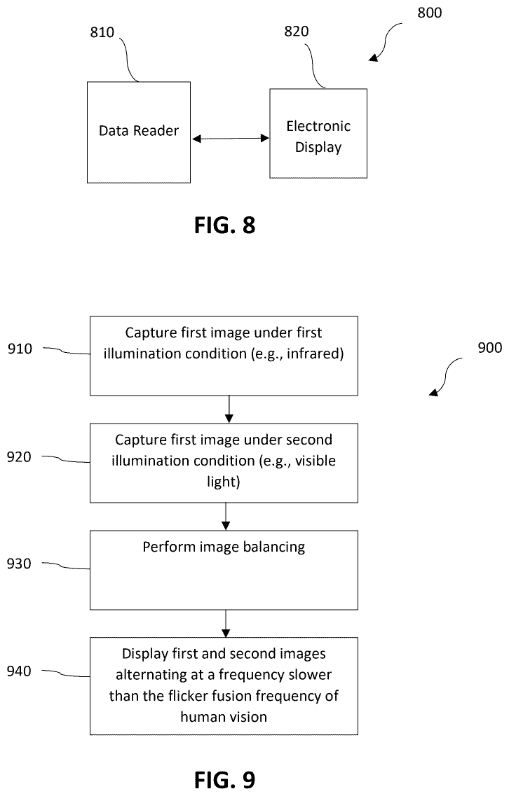

FIG. 8 is a simplified block diagram of a data reading system 800 (also referred to as a “scanning system”) including a data reader 810 and a display 820 according to an embodiment of the disclosure. The data reader 810 may be the data reader of FIGS. 1-3 or other configurations and form factors of a data reader as known in the art, including single plane scanners, multi-plane (e.g., bioptic) scanners, presentation scanners, mobile or handheld scanners, and the like. The data reader 810 may be coupled to the display 820 via wired or wireless connections as known in the art. In the example of FIG. 3, the display 820 may be part of the POS system 160 that is viewable to the user (e.g., cashier). The POS system 160 may be connected via the main board 130, as shown in FIG. 3, or via the multi-port network switch 140 in some embodiments. In other embodiments, the display 820 may be a stand-alone display dedicated to the document assist functionality described herein or another connected device with a display (e.g., wearable device such as glasses). Thus, the display 820 may be a peripheral device connected to the data reader 810. In some embodiments, the display 820 may be integrally formed within the housing of the data reader 810 such as being part of a single form factor if such single form factor may be viewable by the user for the purposes described herein.

Images captured by the data reader 810 may be transmitted to the display 820 for viewing by the user. For the configuration of the data reader of FIG. 3, the images may be captured by the data reader 810 including the base scanner (e.g., cameras 112, 114, 122, 124) or any other connected cameras (e.g., cameras 116, 126, 152, 154, 156), such as through the multi-port network switch 140. The captured image may be of a document, such as a currency note, passport, or other document that includes security features that are visible under different illumination conditions. A first camera exposure may occur during a first illumination condition (e.g., red light, white light, ambient light) for visible light to capture a first image, while a second camera exposure may occur during a second illumination condition (e.g., infrared (IR), ultraviolet (UV), etc.) for non-visible light to capture a second image. The different illumination conditions may be produced by one or more different illumination sources of the data reader 810, including illumination sources within the base scanner (e.g., illumination sources 118, 128) and/or illumination sources that are housed within other devices, such as the TDR 152 or peripheral cameras 154, 156 (see, e.g., FIG. 7). The illumination sources used to produce the different illumination conditions may be the ones having similar fields-of-view as the camera used to capture the images of the item. The illumination sources, therefore, may include one or more different types of LEDs such as red LEDs, white LEDs, RGB LEDs, IR LEDs, UV LEDs, etc. that are triggered at different times depending on the type of illumination desired for a particular exposure of the camera.

The first and second images may be transmitted to the display 820 to be displayed in an alternating manner at a rate that allows the user to visually differentiate between the two images. In some embodiments, the rate of alternating between the different images on the electronic display may be at or less than 15 Hz, which may be a minimum flicker fusion frequency for some people. In some embodiments, the rate of alternating between the different images on the electronic display may in a range between 5 Hz and 15 Hz. In some embodiments, the rate of alternating between the different images on the electronic display may be at or less than 5 Hz. In a preferred embodiment, the images may be displayed in an alternating fashion on an electronic display at an interval of about 0.5 seconds (i.e., 2 Hz). This may have the effect of making the differences between the security features (e.g., IR features, UV features, etc.) stand out to the user's perception to better identify differences between the images. In some embodiments, such alternating may occur automatically on the electronic display, while in some embodiments, the user may be able to control the alternating back and forth between images based on a user input (e.g., by selecting an icon on the display screen, tapping the screen, an input to a keyboard, etc.) as desired rather than at a set frequency.

FIG. 9 is a flowchart 900 illustrating a method of operating a data reader system to perform a document validation assist mode according to embodiments of the disclosure. The document (e.g., currency) validation assist mode may be activated responsive to a user input, such as a button press or touch screen selection when such a document is desired to be checked for validation. In some embodiments, the document validation assist mode may be activated automatically in response to the data reader detecting (e.g., image analysis) such a document is present as opposed to another item for regular barcode scanning. Other triggering methods are also contemplated as known by those skilled in the art.

At operation 910, the data reader may capture a first image under a first illumination condition. In this instance, the first illumination condition may be non-visible illumination (e.g., IR). At operation 920, the data reader may capture a second image under a second illumination condition. In this instance, the second illumination condition may be visible illumination (e.g., white, red, etc.).

At operation 930, image balancing of the first and second images may be performed so that the apparent brightness of the currency note is the same under the two illumination methods. If working with color images, the white balance or other color correction method may be utilized to make colors appear similar under the two different types of illumination. In some embodiments, color images may be converted to monochrome prior to displaying on the display. This use of monochrome would eliminate most color differences and further highlights the brightness differences between the IR features of the first image and regular features of the second image (visible light).

At operation 940, the first image and the second image may be displayed in an alternating manner at a rate that allows the user to visually differentiate between the two images. In some embodiments, the rate of alternating between the different images on the electronic display may be at or less than 15 Hz, which may be a minimum flicker fusion frequency for some people or other low frequencies as described above.

This process may continue while the data reader operates in the document validation assist mode. In such an embodiment, additional first images and additional second images are repeatedly captured under the different illumination conditions and sent to the electronic display to display in an alternating manner at the frequencies described above. In some embodiments, the illumination sources themselves may operate above the flicker fusion frequency of human vision while the image capture function of the data reader may operate at the lower frequency used for displaying the alternating images of the electronic display. As such, only the images shown on the electronic display visibly alternate between the images captured in the different illumination conditions, while the illumination field itself may appear constant to the users. In some embodiments, the illumination sources and the image capture function may operate at the same lower frequency used for displaying the alternating images of the electronic display. Using the same lower frequency for displaying the images may cause visible flickering in the illumination field produced by the data reader.

In some embodiments, this process may end with a single set of images of the document under these different illumination conditions. In some embodiments, the single set of images may include a single first image and a single second image that are sent to the electronic display, which then may switch back and forth between the same images (as opposed to continuously displaying newly captured images under different illumination conditions) at the alternating frequency described above. Or, as described above, the user may be able to control the alternating back and forth between images based on a user input (e.g., by selecting an icon on the display screen, tapping the screen, an input to a keyboard, etc.) as desired rather than at a set frequency. In some embodiment, the single set of images may include a burst of first images and second images that are sent to the electronic display. Such a burst may include a set number of images (e.g., 3 images from each illumination condition) which then may switch back and forth between the same images (as opposed to continuously displaying newly captured images under different illumination conditions) at the alternating frequency described above.

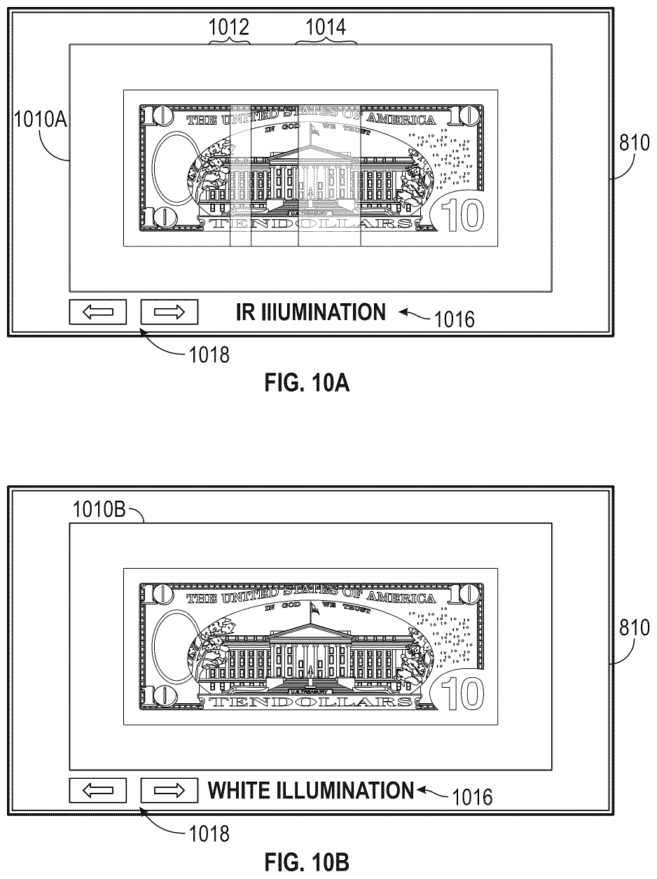

FIGS. 10A-10B show a simplified diagram of the electronic display 810 of FIG. 8 at different instances in time during the document validation assist operation according to embodiments of the disclosure. Thus, FIG. 10A represents the display 810 at a first instance in time when the first image 1010A is being displayed and FIG. 10B represents the display 810 at a second instance in time when the second image 1010B is being displayed. The display 810 may display the images 1010A (FIG. 10A) or 1010B (FIG. 10B) under different illumination conditions in an alternating fashion as described above. The first image 1010A was captured under a first illumination condition (IR illumination), while the second image 1010B was captured under a second illumination condition (white illumination).

As shown in FIG. 10A, the currency note in the first image 1010A shows security features 1012, 1014 (also referred to as “markers”) that are the result of band or bars on the currency note where IR light is not absorbed by the ink. As shown in FIG. 10B, the currency note in the second image 1010B does not show the IR security features due to the same currency note being illuminated by the visible illumination. The first image 1010A and second image 1010B replace each other on the display 810 in an alternating fashion at a low frequency so that the security features 1012, 1014 are more visually apparent and easier to discern by the user. Such alternating display of the images is in contrast to some conventional methods in which a steady state IR image is displayed or a superimposed single image is shown.

The display 810 may include additional visual features, such as labeling text 1016 or another feature, used to identify to the user which illumination condition was applied to the particular image being displayed. The display 810 may also include control icons 1018 that can be selected by the user to manually switch between the captured images. Other controls may also be included, such as a control used to trigger the document validation assist mode, end the document validation assist mode, capture a new set of images, and similar functionality.

While some embodiments show two illumination conditions (e.g., a single non-visible illumination condition and a single visible illumination condition), additional illumination conditions are contemplated. For example, in some embodiments three illumination conditions may be produced in which a first image is captured under IR illumination, a second image is captured under UV illumination, and a third image is captured under visible (e.g., white) illumination. When displayed by the electronic display 810, the three images may alternate individually at a low frequency, as described above, for the user to better discern the differences between the three images. In this case, the order of displaying the images may be IR, UV, visible, IR, UV, visible, and so on. Other methods of displaying the images are also contemplated, such as having a visible light image always between the UV image and the IR image. In this case, the order of displaying the images may be IR, visible, UV, visible, IR, visible, UV, visible, and so on. Of course, the order of the capturing and/or displaying images may be done in any combination of the different illumination conditions.

In some embodiments, the images for the IR and UV illumination conditions may be superimposed as a single image so that the non-visible image conditions appear as a single image and then this superimposed image alternates with the visible light image at a low frequency as described above to better discern between the differences of the combined non-visible light image vs. the visible light image. In this case, the order of displaying images may be IR/UV (superimposed), visible, IR/UV (superimposed), visible, and so on. Thus, there may be more illumination conditions than the actual displayed images in the alternating cycle of images. An example of superimposing an IR image and UV image is described in U.S. Pat. No. 9,672,678, issued Jun. 6, 2017, and entitled “METHOD AND SYSTEM OF USING IMAGE CAPTURING DEVICE FOR COUNTERFEIT ARTICLE DETECTION,” the disclosure of which is incorporated by reference herein in its entirety.

In some embodiments, alternatingly switching between different illumination conditions and displaying the resulting images at low frequencies may include switching between images captured during any combination of different visible light conditions and/or different non-visible light conditions to distinguish between security features present in the document. If such security features are distinguishable between different visible light conditions, embodiments of the disclosure may alternate between displaying images from such visible light conditions only. Similarly, if such security features are distinguishable between different non-visible light conditions, embodiments of the disclosure may alternate between displaying images from such non-visible light conditions only.

In some embodiments, the captured images under the different illumination conditions may be analyzed (e.g., by on-board processors 135 of FIG. 1) to identify the security features or at least recognize the differences between the images prior to the images being displayed to the user. An example of such data readers having additional on-board processing available for such analysis, such as by AI accelerator, is described in U.S. Pat. No. 12,141,648, issued Nov. 12, 2024, and entitled “FIXED RETAIL SCANNER WITH ON-BOARD ARTIFICIAL INTELLIGENCE (AI) ACCELERATOR MODULE AND RELATED METHODS,” the disclosure of which is incorporated by reference herein in its entirety.

As an example, an AI model may be trained and operated by an AI accelerator or other processor within the data reader to recognize differences between the images and/or specifically identify the security features for the given document type in the image. Such items may be annotated (e.g., by a bounding box, text, arrows, etc.) in the images when they are displayed during the alternating cycle to better indicate to the user where to look for such security features. In embodiments, where the processor (e.g., AI model) may be used to specifically recognize the security features, the annotations with the images may result in the display providing an indication of a positive match (e.g., green bounding box, green highlighting some portion of the display, a positive textual message displayed, a positive beep, etc.) vs. a non-match for a counterfeit document (e.g., red bounding box, red highlighting some portion of the display, a negative textual message displayed, a lack of a positive beep, etc.) Of course, other methods of indication or alerts are also contemplated.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed:

1. A scanning system, comprising:
a data reader comprising:
at least one camera configured to capture images of an item;
at least one visible illumination source;
at least one non-visible illumination source;
at least one processor configured to:
control the exposure of the at least one camera and activate the at least one visible illumination source and the non-visible illumination source;
decode optical symbols on the item from images captured during a decoding operational mode; and
capture a first image under a first illumination condition using the at least one visible light source, a second image under a second illumination condition using the at least one non-visible light source during a document validation assist mode; and
an electronic display operably coupled to the data reader to receive the images from the data reader during the document validation assist mode, the electronic display configured to display the first and second images in an alternating fashion at a frequency slower than a minimum flicker fusion frequency for human vision.

2. The scanning system of claim 1, wherein the frequency for alternating the images is at or less than 15 Hz.

3. The scanning system of claim 1, wherein the frequency for alternating the images is in a range between 5 Hz and 15 Hz.

4. The scanning system of claim 1, wherein the frequency for alternating the images is in at or less than 5 Hz.

5. The scanning system of claim 1, wherein the frequency for alternating the images is in about 2 Hz.

6. The scanning system of claim 1, wherein the frequency for alternating the images controlled by a manual user input for switching between the images.

7. The scanning system of claim 1, wherein the data reader is a fixed retail scanner including a top-down reader operably coupled thereto, the top-down reader including the at least one camera, the at least one visible illumination source, and the at least one non-visible illumination source used to capture images during the document validation assist mode.

8. The scanning system of claim 1, wherein the data reader is one of a fixed retail scanner, a presentation scanner, a mobile or handheld scanner, or a wearable scanner.

9. The scanning system of claim 1, wherein the visible illumination source produces at least one of red light or white light, and wherein the non-visible illumination source produces at least one of infrared (IR) or ultraviolet (UV) light.

10. A method of operating a scanning system to perform a document validation assist mode, the method comprising:
capturing a first image under a first illumination condition of non-visible light;
capturing a second image under a second illumination condition of visible light;
transmitting the first image and the second image from a data reader to a connected electronic display; and
alternatingly displaying the first and second images on the connected electronic display at a rate less than a minimum flicker fusion frequency for human vision.

11. The method of claim 10, wherein the visible light is at least one of a red light or a white light, and the non-visible light at least one of infrared (IR) or ultraviolet (UV) light.

12. The method of claim 10, further comprising image balancing the first image and the second image so that the apparent brightness of the document is the same under the first and second illumination conditions.

13. The method of claim 12, wherein the image balancing includes at least one of white balance, color correction, conversion of the first and second images to monochrome images, or any combination thereof.

14. The method of claim 10, further comprising continuously capturing first images and second images under the respective illumination conditions during the document validation assist mode.

15. The method of claim 10, further comprising capturing a third image under a third illumination condition of non-visible light, wherein transmitting and alternatingly displaying include the third image, and wherein the first illumination condition is IR light and the third illumination condition is UV light.

16. The method of claim 10, further comprising:
capturing a third image under a third illumination condition of non-visible light; and
superimposing the first and the third image as a single image to be alternatingly displayed with the second image, wherein the first illumination condition is IR light and the third illumination condition is UV light.

17. The method of claim 10, wherein the first image and the second image are transmitted as a single set of images, and the alternatingly displaying switches back and forth between the same first and second images of the single set of images.

18. The method of claim 10, further comprising:
analyzing, via a processor of the data reader, the first image and second image to detect differences therebetween;
annotating the images transmitted to the electronic display; and
providing an indication to the user of the detected differences.

19. The method of claim 18, wherein providing an indication to the user includes displaying a visual indicator around or in proximity to the detected differences.

20. A method of operating a scanning system to perform a document validation assist mode, the method comprising:
capturing a first image under a first illumination condition that shows at least one security feature present on the document;
capturing a second image under a second illumination condition that does not show the at least one security feature present on the document;
transmitting the first image and the second image from a data reader to a connected electronic display; and
alternatingly displaying the first and second images on the connected electronic display at a rate less than a minimum flicker fusion frequency for human vision to allow a user to distinguish between the images and identify the at least one security feature.
